(19) United States
(12) Patent Application Publication
(10) Pub. No.: US 2025/0355779 A1
(43) Pub. Date: Nov. 20, 2025

(54) APPARATUS, METHOD AND COMPUTER PROGRAM

(71) Applicant: Nokia Technologies Oy, Espoo (FI)

(72) Inventors: Sivaramakrishnan SWAMINATHAN, Bangalore (IN); Shu Qiang SUN, Chengdu (CN); Tejas SUBRAMANYA, Munich (DE); Anna PANTELIDOU, Massy (FR)

(21) Appl. No.: 18/872,021

(22) PCT Filed: Jun. 17, 2022
(86) PCT No.: PCT/CN2022/099410

§ 371 Date: Dec. 5, 2024

(51) Int. Cl. G06F 11/34

(52) U.S. Cl. CPC G06F 11/3447

(57) ABSTRACT

An apparatus is disclosed, said apparatus comprising means for determining, for a given use case, a behavioural requirement policy for a machine learning model, means for providing an indication of the behavioural requirement policy to an analytics producer and means for receiving, from the analytics producer, a performance evaluation metric determined based on the behavioural requirement policy.

### FIELD

The present application relates to a method, apparatus, system and computer program and in particular but not exclusively to Artificial Intelligence (AI)/Machine Learning (ML) model training.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

In a first aspect there is provided an apparatus comprising means for determining, for a given use case, a behavioural requirement policy for a machine learning model, means for providing an indication of the behavioural requirement policy to an analytics producer and means for receiving, from the analytics producer, a performance evaluation metric determined based on the behavioural requirement policy.

The apparatus may comprise means for receiving, from the analytics producer, a performance evaluation metric value or a performance evaluation metric value list determined based on the behavioural requirement policy.

The indication of the behavioural requirement policy may comprise an indication of at least one associated performance evaluation metric.

The apparatus may comprise means for receiving from the analytics producer, an indication of at least one behavioural requirement policy associated with the machine learning model for a given use case.

The apparatus may comprise means for receiving from the analytics producer, the indication of at least one behavioural requirement policy associated with the machine learning model for a given use case in a broadcast message.

The apparatus may comprise means for providing a request to the analytics producer for the at least one policy associated with the machine learning model for the given use case and receiving the indication of the at least one policy from the analytics producer in response.

The performance evaluation metric may comprise at least one of precision, accuracy, recall, f1-score, mean squared error, mean absolute error and root mean squared error.

In a second aspect there is provided an apparatus comprising means for receiving an indication of a behavioural requirement policy for a given use case from an analytics consumer, means for determining a performance evaluation metric based on the indication and means for providing, to the analytics consumer, the determined performance evaluation metric.

The apparatus may comprise means for providing, to the analytics consumer, a performance evaluation metric value determined based on the behavioural requirement policy.

The indication of the behavioural requirement policy may comprise an indication of at least one associated performance evaluation metric.

The apparatus may comprise means for providing to the analytics consumer, an indication of at least one behavioural requirement policy associated with the machine learning model for a given use case.

The apparatus may comprise means for providing the indication of at least one performance requirement policy associated with the machine learning model for a given use case to the analytics consumer in a broadcast message.

The apparatus may comprise means for receiving a request from the analytics consumer for the at least one policy associated with the machine learning model for the given use case and providing the indication of the at least one policy to the analytics consumer in response.

The performance evaluation metric may comprise at least one of precision, accuracy, recall, f1-score, mean squared error, mean absolute error and root mean squared error.

The apparatus may comprise means for requesting data for use in training the machine learning model from at least one data source, receiving data for use in training the machine learning model from the at least one data source, determining if the data for use in training the machine learning model allows the performance evaluation metric to be satisfied and, if so, training the machine learning model using the data and if not, requesting further data for use in training the machine learning model from the at least one data source.

In a third aspect there is provided a method comprising determining, for a given use case, a behavioural requirement policy for a machine learning model, providing an indication of the behavioural requirement policy to an analytics producer and receiving, from the analytics producer, a performance evaluation metric determined based on the behavioural requirement policy.

The method may comprise receiving, from the analytics producer, a performance evaluation metric value or a performance evaluation metric value list determined based on the behavioural requirement policy.

The indication of the behavioural requirement policy may comprise an indication of at least one associated performance evaluation metric.

The method may comprise receiving from the analytics producer, an indication of at least one behavioural requirement policy associated with the machine learning model for a given use case.

The method may comprise receiving from the analytics producer, the indication of at least one behavioural requirement policy associated with the machine learning model for a given use case in a broadcast message.

The method may comprise providing a request to the analytics producer for the at least one policy associated with the machine learning model for the given use case and receiving the indication of the at least one policy from the analytics producer in response.

The performance evaluation metric may comprise at least one of precision, accuracy, recall, f1-score, mean squared error, mean absolute error and root mean squared error.

In a fourth aspect there is provided a method comprising receiving an indication of a behavioural requirement policy for a given use case from an analytics consumer, determining a performance evaluation metric based on the indication and providing, to the analytics consumer, the determined performance evaluation metric.

The method may comprise providing, to the analytics consumer, a performance evaluation metric value determined based on the behavioural requirement policy.

The indication of the behavioural requirement policy may comprise an indication of at least one associated performance evaluation metric.

The method may comprise providing to the analytics consumer, an indication of at least one behavioural requirement policy associated with the machine learning model for a given use case.

The method may comprise providing the indication of at least one performance requirement policy associated with the machine learning model for a given use case to the analytics consumer in a broadcast message.

The method may comprise receiving a request from the analytics consumer for the at least one policy associated with the machine learning model for the given use case and providing the indication of the at least one policy to the analytics consumer in response.

The performance evaluation metric may comprise at least one of precision, accuracy, recall, f1-score, mean squared error, mean absolute error and root mean squared error.

The method may comprise requesting data for use in training the machine learning model from at least one data source, receiving data for use in training the machine learning model from the at least one data source, determining if the data for use in training the machine learning model allows the performance evaluation metric to be satisfied and, if so, training the machine learning model using the data and if not, requesting further data for use in training the machine learning model from the at least one data source.

In a fifth aspect there is provided an apparatus comprising: at least one processor and at least one memory including a computer program code, the at least one memory and computer program code configured to, with the at least one processor, cause the apparatus at least to: determine, for a given use case, a behavioural requirement policy for a machine learning model, provide an indication of the behavioural requirement policy to an analytics producer; and receive, from the analytics producer, a performance evaluation metric determined based on the behavioural requirement policy.

The apparatus may be configured to receive, from the analytics producer, a performance evaluation metric value or a performance evaluation metric value list determined based on the behavioural requirement policy.

The indication of the behavioural requirement policy may comprise an indication of at least one associated performance evaluation metric.

The apparatus may be configured to receive from the analytics producer, an indication of at least one behavioural requirement policy associated with the machine learning model for a given use case.

The apparatus may be configured to receive from the analytics producer, the indication of at least one behavioural requirement policy associated with the machine learning model for a given use case in a broadcast message.

The apparatus may be configured to provide a request to the analytics producer for the at least one policy associated with the machine learning model for the given use case and receive the indication of the at least one policy from the analytics producer in response.

The performance evaluation metric may comprise at least one of precision, accuracy, recall, f1-score, mean squared error, mean absolute error and root mean squared error.

In a sixth aspect there is provided an apparatus comprising: at least one processor and at least one memory including a computer program code, the at least one memory and computer program code configured to, with the at least one processor, cause the apparatus at least to: receive an indication of a behavioural requirement policy for a given use case from an analytics consumer, determine a performance evaluation metric based on the indication and provide, to the analytics consumer, the determined performance evaluation metric.

The apparatus may be configured to provide, to the analytics consumer, a performance evaluation metric value determined based on the behavioural requirement policy.

The indication of the behavioural requirement policy may comprise an indication of at least one associated performance evaluation metric.

The apparatus may be configured to provide to the analytics consumer, an indication of at least one behavioural requirement policy associated with the machine learning model for a given use case.

The apparatus may be configured to provide the indication of at least one performance requirement policy associated with the machine learning model for a given use case to the analytics consumer in a broadcast message.

The apparatus may be configured to receive a request from the analytics consumer for the at least one policy associated with the machine learning model for the given use case and provide the indication of the at least one policy to the analytics consumer in response.

The performance evaluation metric may comprise at least one of precision, accuracy, recall, f1-score, mean squared error, mean absolute error and root mean squared error.

The apparatus may be configured to request data for use in training the machine learning model from at least one data source, receive data for use in training the machine learning model from the at least one data source, determine if the data for use in training the machine learning model allows the performance evaluation metric to be satisfied and, if so, train the machine learning model using the data and if not, request further data for use in training the machine learning model from the at least one data source.

In a seventh aspect there is provided a computer readable medium comprising program instructions for causing an apparatus to perform at least the following, determining, for a given use case, a behavioural requirement policy for a machine learning model, providing an indication of the behavioural requirement policy to an analytics producer and receiving, from the analytics producer, a performance evaluation metric determined based on the behavioural requirement policy.

The apparatus may be caused to perform receiving, from the analytics producer, a performance evaluation metric value or a performance evaluation metric value list determined based on the behavioural requirement policy.

The indication of the behavioural requirement policy may comprise an indication of at least one associated performance evaluation metric.

The apparatus may be caused to perform receiving from the analytics producer, an indication of at least one behavioural requirement policy associated with the machine learning model for a given use case.

The apparatus may be caused to perform receiving from the analytics producer, the indication of at least one behavioural requirement policy associated with the machine learning model for a given use case in a broadcast message.

The apparatus may be caused to perform providing a request to the analytics producer for the at least one policy associated with the machine learning model for the given use case and receiving the indication of the at least one policy from the analytics producer in response.

The performance evaluation metric may comprise at least one of precision, accuracy, recall, f1-score, mean squared error, mean absolute error and root mean squared error.

In an eighth aspect there is provided a computer readable medium comprising program instructions for causing an apparatus to perform at least the following receiving an indication of a behavioural requirement policy for a given use case from an analytics consumer, determining a performance evaluation metric based on the indication and providing, to the analytics consumer, the determined performance evaluation metric.

The apparatus may be caused to perform providing, to the analytics consumer, a performance evaluation metric value determined based on the behavioural requirement policy.

The indication of the behavioural requirement policy may comprise an indication of at least one associated performance evaluation metric.

The apparatus may be caused to perform providing to the analytics consumer, an indication of at least one behavioural requirement policy associated with the machine learning model for a given use case.

The apparatus may be caused to perform providing the indication of at least one performance requirement policy associated with the machine learning model for a given use case to the analytics consumer in a broadcast message.

The apparatus may be caused to perform receiving a request from the analytics consumer for the at least one policy associated with the machine learning model for the given use case and providing the indication of the at least one policy to the analytics consumer in response.

The performance evaluation metric may comprise at least one of precision, accuracy, recall, f1-score, mean squared error, mean absolute error and root mean squared error.

The apparatus may be caused to perform requesting data for use in training the machine learning model from at least one data source, receiving data for use in training the machine learning model from the at least one data source, determining if the data for use in training the machine learning model allows the performance evaluation metric to be satisfied and, if so, training the machine learning model using the data and if not, requesting further data for use in training the machine learning model from the at least one data source.

In a ninth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a flow diagram of a method according to an example embodiment;

FIG. 5 shows a flow diagram of a method according to an example embodiment;

FIG. 6 shows a signalling flow according to an example embodiment.

### DETAILED DESCRIPTION

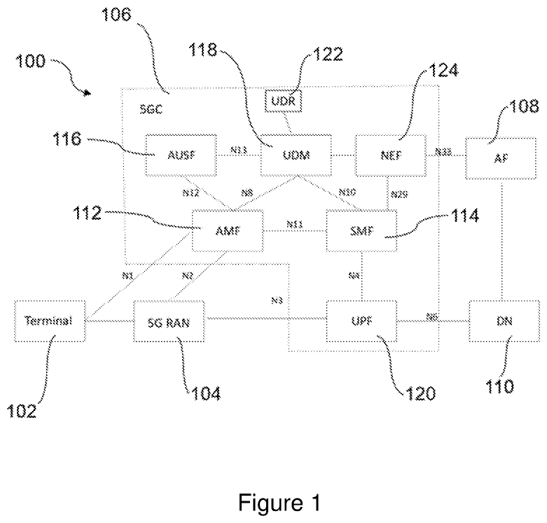

Before explaining in detail the examples, certain general principles of a wireless communication system and mobile communication devices are briefly explained with reference to FIGS. 1 to 3 to assist in understanding the technology underlying the described examples.

An example of a suitable communications system is the 5G System (5GS). Network architecture in 5GS may be similar to that of LTE-advanced. Base stations of NR systems may be known as next generation Node Bs (gNBs). Changes to the network architecture may depend on the need to support various radio technologies and finer QoS support, and some on-demand requirements for example QoS levels to support QoE of user point of view. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

5G networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more application functions (AF) 108 and one or more data networks (DN) 110.

An example 5G core network (CN) comprises functional entities. The 5GCN 106 may comprise one or more access and mobility management functions (AMF) 112, one or more session management functions (SMF) 114, an authentication server function (AUSF) 116, a unified data management (UDM) 118, one or more user plane functions (UPF) 120, a unified data repository (UDR) 122 and/or a network exposure function (NEF) 124. The UPF is controlled by the SMF (Session Management Function) that receives policies from a PCF (Policy Control Function).

The CN is connected to a terminal device via the radio access network (RAN). The 5GRAN may comprise one or more gNodeB (GNB) distributed unit functions connected to one or more gNodeB (GNB) centralized unit functions. The RAN may comprise one or more access nodes.

A UPF (User Plane Function) whose role is called PSA (Protocol Data Unit (PDU) Session Anchor) may be responsible for forwarding frames back and forth between the DN (data network) and the tunnels established over the 5G towards the UE(s) exchanging traffic with the DN.

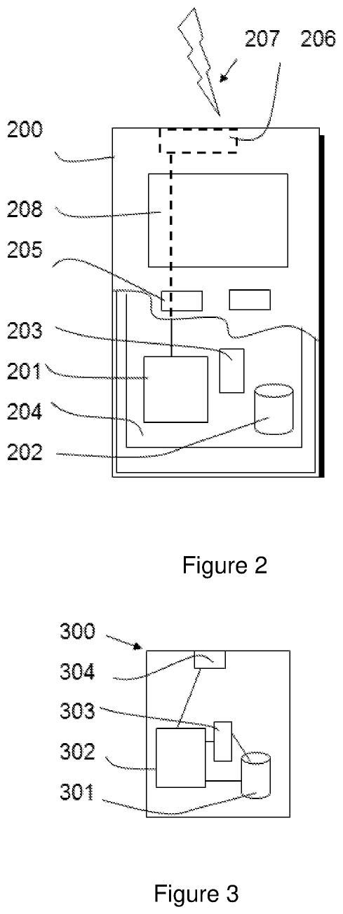

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VOIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

FIG. 3 shows an example of a control apparatus 300 for a communication system, for example to be coupled to and/or for controlling a station of an access system, such as a RAN node, e.g. a base station, eNB or gNB, a relay node or a core network node such as an MME or S-GW or P-GW, or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

AI/ML model training is performed for various optimization and prediction use cases. The training process tries to achieve the best possible model for a given task. This is achieved based on various performance evaluation metrics chosen for the model during the training procedure. The hyper-parameters of the models are finetuned to achieve the best performance evaluation metric scores. The choice of the performance evaluation metric, and the choice of the best score for that performance evaluation metric, plays a key role in the performance of a trained model for a given use case.

One example of a performance evaluation metric for an AI/ML classification model is accuracy. Accuracy is a measure that gives the proportion of true predictions among the total number of predictions observed. However, accuracy is a useful measure only if the datasets are entirely symmetric, i.e., false positives and false negatives are almost the same. Therefore, other performance evaluation metrics are to be considered when evaluating a model.

Precision is a measure of correctly predicted positive observations to the total predicted positive observations. It is a useful measure if the cost of False Positives (FP) is high.

Recall is a measure that calculates how many of the actual positives are captured in the model. It is a useful measure if the cost of False Negatives (FN) is high.

Finally, F-measure is the weighted average of precision and recall, and it is used when there is an uneven class distribution.

One example of a performance evaluation metric for an AI/ML regression case is Mean Absolute Error (MAE). MAE estimates the average magnitude of errors in a set of forecasts, without considering their direction (i.e., the average of the absolute values of differences between the forecast and the corresponding observation).

Mean Squared Error (MSE) measures the average of the squares of the errors (i.e., the average squared difference between the estimated values and the actual values).

Root Mean Squared Error (RMSE) is a quadratic scoring rule which measures the average magnitude of the error (i.e., the difference between the estimated values and the actual values are each squared and then averaged over the sample). Then, the square root of the average is estimated. Considering the errors are squared before they are averaged, the RMSE adds a relatively high weight to big errors. Therefore, RMSE is most useful when large errors are undesirable. The RMSE is always larger or equal to the MAE, the greater difference between them, the higher the variance in the individual errors in the sample. If the RMSE is equal to the MAE, then all the errors are of the same magnitude.

R2-score (coefficient of determination) represents the coefficient of how well the values fit compared to the original values. The value from 0 to 1 are interpreted as percentages. R2-score measures the proportion of variation in the data that is accounted for in the model. It is equivalent to the accuracy metric in classification problems.

A Management Service (MnS) consumer requests AI/ML model training from a MnS producer. When training an AI/ML model, the MnS producer collects the necessary data, trains the AI/ML model corresponding to a requested performance evaluation metric and then deploys the AI/ML model for inference. The MnS producer notifies or responds to the MnS consumer to provide information related to the AI/ML model training.

A MnS producer trains the AI/ML model (e.g., by choosing relevant hyperparameters and/or adjusting decision thresholds) to optimize a performance evaluation metric chosen by the MnS consumer.

Different use cases may have different behavioural requirements. For a regression/time-series technique, for example, a particular use case may be more sensitive to over-prediction of numeric values while another use case may be more sensitive to under-prediction of numeric values.

As an example, in virtual network function (VNF) auto-scaling, if the objective of the MnS consumer is to minimize cost, then training (or fine-tuning) the AI/ML model to minimize false positives (i.e., to limit the over-provisioning of resources which in turn leads to increased operational cost) would be useful whereas, if the objective of the MnS consumer is to maximize QoS, then training (or fine-tuning) the AI/ML model to minimize false negatives (i.e., to limit the under-provisioning of resources which in turn leads to decreased QoS performance) would be more appropriate.

Therefore, it would be desirable for the MnS consumer to have a means to provide a behavioural requirement that the trained AI/ML model should comply with depending on the objective of VNF auto-scaling, e.g., policy (false positives, low), policy (false negatives, low), policy (false positives, false negatives, balanced)).

There is currently no means for the MnS consumer to provide customized (i.e., use case specific) behavioural requirements, for, e.g., false positives false negatives, and accuracy in classification problems or MSE, MAE, RMSE, over-predictions and under-predictions in regression/time-series problems, for an MnS producer to satisfy during AI/ML model training.

There is also currently no means for the MnS producer to choose by itself (i.e., depending on the use case for which the AI/ML model is being trained for) the most appropriate performance evaluation metrics (e.g., precision is a good measure to evaluate and report when the cost of false positive is high, recall is a good measure to evaluate and report when the cost of FN is high) that should be reported to the MnS consumer.

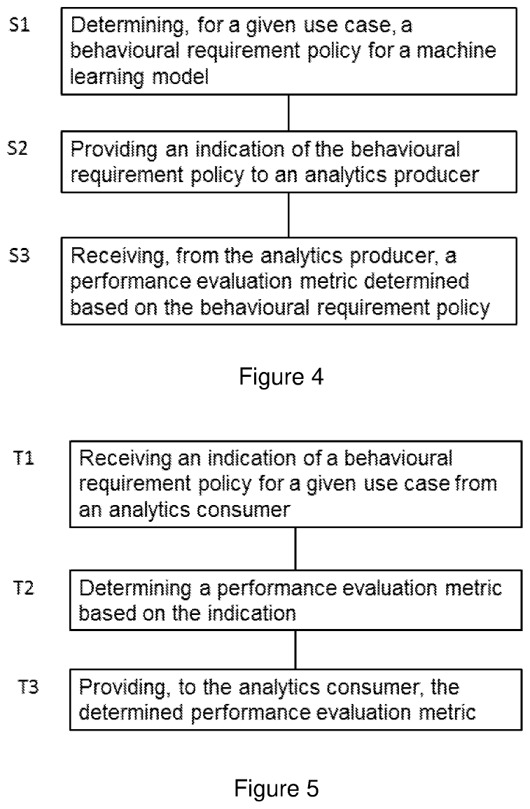

FIG. 4 shows a flowchart of a method according to an example embodiment. The method may be performed at an analytics consumer, e.g., a MnS consumer such as a UE or any 3GPP management entity that would consume AIML training services.

In S1, the method comprises determining, for a given use case, a behavioural requirement policy for a machine learning model.

In S2, the method comprises providing an indication of the behavioural requirement policy to an analytics producer.

In S3, the method comprises receiving, from the analytics producer, a performance evaluation metric determined based on the behavioural requirement policy.

FIG. 5 shows a flowchart of a method according to an example embodiment. The method may be performed at an analytics producer, e.g., a MnS producer.

In T1, the method comprises receiving an indication of a behavioural requirement policy, for a given use case, from an analytics consumer.

In T2, the method comprises determining a performance evaluation metric based on the indication.

In T3, the method comprises providing, to the analytics consumer, the determined performance evaluation metric.

The indication of the behavioural requirement policy provided from the analytics consumer to the analytics producer may comprise an indication of at least one associated performance evaluation metric.

In an example embodiment, the consumer indicates the required behavioural related requirements in the AIMLT training request to the producer. The indication may capture the different possible evaluation metrics for a given training use case.

The method enables an analytics consumer and producer to indicate a preferred and used performance evaluation metric for a given use case, respectively.

The method may comprise receiving, from the analytics producer, a performance evaluation metric value or performance evaluation metric value list determined based on the performance requirement policy.

Examples for the behavioural requirement policies may include but are not limited to the following.

### Classification:

“False Positives, Low”
“False Positives, High” “False
Negatives, Low” “False
Negatives, High”

### Regression:

“Over-Prediction, High”
“Over-Prediction, Low”
“Under-Prediction, High”
“Under-Prediction, Low”

The performance evaluation metric may comprise, but is not limited to, at least one of precision, accuracy, recall, f1-score, MSE, MAE and RMSE.

The method provides a mechanism to enable a MnS consumer to provide customized (in other words, use case specific) behavioural requirements to the the MnS producer. During AI/ML model training, the MnS producer considers those requirements.

The MnS producer may determine the most relevant/useful performance evaluation metrics depending on the use case and associated behavioural requirements for which the AI/ML model is being trained for (e.g., precision is a good measure to evaluate and report when the cost of false positive is high, recall is a good measure to evaluate and report when the cost of FN is high) that should be reported to the MnS consumer and subsequently reports them.

In the case of classification, certain use cases may be sensitive to false positives while other use cases may be sensitive to false negatives. In the case of regression or time-series scenarios, certain use cases may be sensitive to over predicting the numeric value and certain cases may be sensitive to under prediction.

Other use cases may require a balanced metric for best results.

The analytics producer may make use of the information from the consumer to choose the right evaluation metric for training and finetuning the model and report the chosen performance metric and the score for the resultant model.

The method may comprise, at the analytics producer, requesting data for use in training the machine learning model from at least one data source, receiving data for use in training the machine learning model from the at least one data source, determining if the data for use in training the machine learning model allows the performance evaluation metric to be satisfied and, if so, training the machine learning model using the data and if not, requesting further data for use in training the machine learning model from the at least one data source.

The method may comprise receiving at the analytics consumer from the analytics producer, an indication of at least one behavioural requirement policy associated with the machine learning model for a given use case.

The indication of at least one behavioural requirement policy associated with the machine learning model for a given use case may be provided to the analytics consumer in a broadcast message.

Alternatively, or in addition, the method may comprise providing a request to the analytics producer from the analytics consumer for the at least one policy associated with the machine learning model for the given use case and receiving the indication of the at least one policy from the analytics producer at the analytics consumer in response.

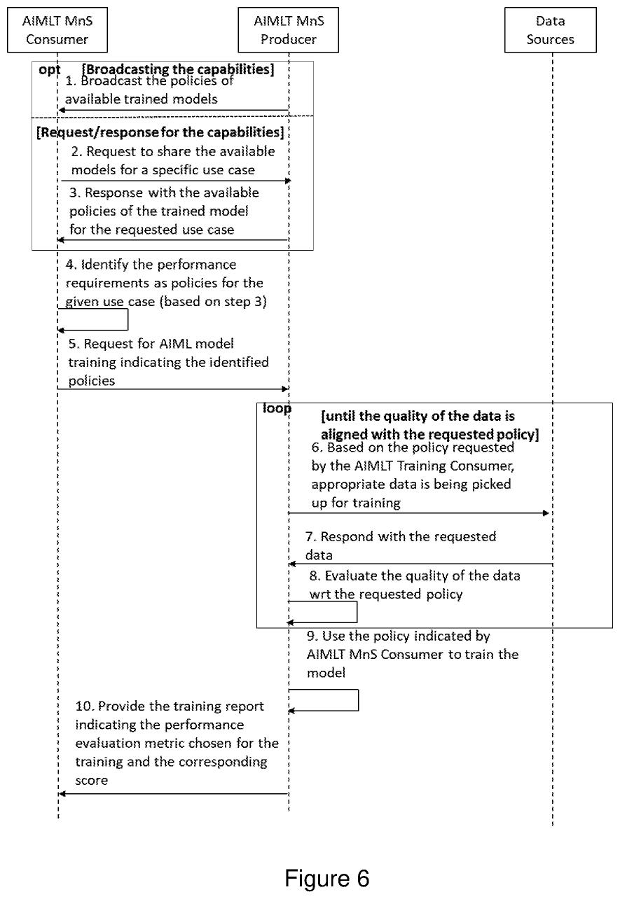

FIG. 6 shows a signalling flow between an AI/ML Training (AIMLT) MnS Consumer, AIMLT MnS Producer and data sources according to an example embodiment.

Steps 1 to 3 are optional.

In step 1, the AIMLT MnS Producer broadcasts the policies of the available models periodically to the AIMLT MnS consumers.

In step 2, the AIMLT MnS consumer makes a request for the available policies from the AIMLT MnS producer for the trained and available ML models for a given use case.

In step 3, the AIMLT MnS producer responds with the available policies from the available trained ML models for the given use case to the AIMLT MnS consumer.

In step 4, the AIMLT MnS Consumer identifies the use case and appropriate behavioural and training requirements as policies for the identified use case (alternatively, the consumer may choose a policy indicated by the producer in step 1 or 3).

Behavioural requirements may be indicated as sensitivity inferences for a given use case as a policy. For example, for a classification use case, the behavioural requirement may be policy (“False Positives, Low”) or policy (“False Negatives, Low”) or policy (“False Positives, False Negatives, Balanced”). For a regression/time series use case the behavioural requirement may be policy (“Over-prediction, Low”) or policy (“Under-prediction, Low”).

In step 5, the AIMLT MnS Consumer indicates a request for AIML model training along with the behavioural and training requirements as policies identified in Step 4 to AIMLT MnS producer.

In step 6, based on the policy indicated by the AIMLT MnS consumer, the AIMLT MnS producer requests the appropriate data from the data sources.

In step 7, the data sources respond to the AIMLT MnS Producer with the requested data.

In step 8, the AIMLT MnS Producer evaluates the data received with respect to the policy indicated by the AIMLT MnS consumer. If the data is not of the required quality to meet the policy indicated by the AIMLT MnS consumer, the AIMLT MnS producer requests the data sources to provide the data with the required quality.

Steps 6, 7 and 8 are executed in a loop until the AIMLT MnS training producer is provided with the right quality of data to train a model for the indicated policy.

In step 9, after receiving the data with expected quality to accommodate the requested policy, AIMLT MnS training producer initiates the training of the model. The producer also chooses the appropriate evaluation metric in line with the requested policy.

In the process of the training, the policy indicated also influences the determination of the threshold for the chosen evaluation metric.

In step 10, the AIMLT MnS Consumer provides the training report indicating the chosen evaluation metric and the corresponding performance score.

For a classification use case, the performance evaluation metric may be, but is not limited to, “Precision”, “Recall”, or “F1 score”. For a regression/time series use case, the performance evaluation metric may be, but is not limited to, “MSE”, “MAE or “RMSE”.

For example, the use case may be Mobility Robustness Optimization and the inference is a classification problem to identify whether the handover of a call from source to target gNB would be successful, and the source gNB is resource rich whereas the target gNB has restricted resources. In this scenario, it would be acceptable for the source gNB to hold on to the call for a longer time period before the Handover as the possibility of the HO failing is more since the target gNB is resource restricted. This use case is sensitive to false positives because if there is a decision by the model to perform HO by mistake, the call drop possibility increases.

In this scenario, the behavioural requirements would indicate that the use case is sensitive to high false positive inferences. The AIMLT MnS producer uses the requirements to determine an appropriate evaluation metric, e.g., Precision, for the training. The policy chosen for this example scenario would be policy (False Positives, High).

For example, in this scenario, in order to minimize the false positives, the decision boundary shall not be 0.5 (as the case in regular binary classification) but greater than 0.5.

In step 8 of a signalling flow as shown in FIG. 5, the data would require adequate representation of the false positives so that the training process can focus to minimize the false positive inferences by the model. In case of inadequate representation of false positives, AIMLT MnS producer requests for more data from the data sources.

An apparatus may comprise means for determining, for a given use case, a behavioural requirement policy for a machine learning model, means for providing an indication of the behavioural requirement policy to an analytics producer and means for receiving, from the analytics producer, a performance evaluation metric determined based on the behavioural requirement policy.

Alternatively, or in addition, an apparatus may comprise means for receiving an indication of a behavioural requirement policy for a given use case from an analytics consumer, means for determining a performance evaluation metric based on the indication and means for providing, to the analytics consumer, the determined performance evaluation metric.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising: at least one processor and at least one memory including a computer program code, the at least one memory and computer program code configured to, with the at least one processor, cause the apparatus at least to perform:
determining, for a given use case, a behavioural requirement policy for a machine learning model;
providing an indication of the behavioural requirement policy to an analytics producer; and
receiving, from the analytics producer, a performance evaluation metric determined based on the behavioural requirement policy.

2. An apparatus according to claim 1, being further caused to perform: receiving, from the analytics producer, a performance evaluation metric value or a performance evaluation metric value list determined based on the behavioural requirement policy.

3. An apparatus according to claim 1, wherein the indication of the behavioural requirement policy comprises an indication of at least one associated performance evaluation metric.

4. An apparatus according to claim 1, being further caused to perform:
receiving from the analytics producer, an indication of at least one behavioural requirement policy associated with the machine learning model for a given use case.

5. An apparatus according to claim 4, being further caused to perform: receiving from the analytics producer the indication of at least one behavioural requirement policy associated with the machine learning model for a given use case in a broadcast message.

6. An apparatus according to claim 4, being further caused to perform:
providing a request to the analytics producer for the at least one policy associated with the machine learning model for the given use case and receiving the indication of the at least one policy from the analytics producer in response.

7. An apparatus according to claim 1, wherein the performance evaluation metric comprises at least one of precision, accuracy, recall, f1-score, mean squared error, mean absolute error and root mean squared error.

8. An apparatus comprising: at least one processor and at least one memory including a computer program code, the at least one memory and computer program code configured to, with the at least one processor, cause the apparatus at least to perform:
receiving an indication of a behavioural requirement policy for a given use case from an analytics consumer;
determining a performance evaluation metric based on the indication; and
providing, to the analytics consumer, the determined performance evaluation metric.

9. An apparatus according to claim 8, being further caused to perform: providing, to the analytics consumer, a performance evaluation metric value determined based on the behavioural requirement policy.

10. An apparatus according to claim 8, wherein the indication of the behavioural requirement policy comprises an indication of at least one associated performance evaluation metric.

11. An apparatus according to claim 8, being further caused to perform:
providing to the analytics consumer, an indication of at least one behavioural requirement policy associated with the machine learning model for a given use case.

12. An apparatus according to claim 11, being further caused to perform: providing the indication of at least one performance requirement policy associated with the machine learning model for a given use case to the analytics consumer in a broadcast message.

13. An apparatus according to claim 11, being further caused to perform:
receiving a request from the analytics consumer for the at least one policy associated with the machine learning model for the given use case and providing the indication of the at least one policy to the analytics consumer in response.

14. An apparatus according to claim 8, wherein the performance evaluation metric comprises at least one of precision, accuracy, recall, f1-score, mean squared error, mean absolute error and root mean squared error.

15. An apparatus according to claim 8, being further caused to perform; requesting data for use in training the machine learning model from at least one data source;
receiving data for use in training the machine learning model from the at least one data source;
determining if the data for use in training the machine learning model allows the performance evaluation metric to be satisfied; and
if so, training the machine learning model using the data and if not, requesting further data for use in training the machine learning model from the at least one data source.

16. A method comprising:
determining, for a given use case, a behavioural requirement policy for a machine learning model;
providing an indication of the behavioural requirement policy to an analytics producer; and
receiving, from the analytics producer, a performance evaluation metric determined based on the behavioural requirement policy.

17-21. (canceled)
